(19) United States
(12) Patent Application Publication
(10) Pub. No.: US 2008/0024396 A1
(43) Pub. Date: Jan. 31, 2008

(54) Front substrate of plasma display panel

(76) Inventor: Cheol Hee Moon, Chungcheongnam-do (KR)

Correspondence Address: ROSENBERG, KLEIN & LEE, 3458 ELLICOTT CENTER DRIVE-SUITE 101, ELLICOTT CITY, MD, 21043, US

(21) Appl. No.: 11/802,789

(22) Filed: May 25, 2007

(30) Foreign Application Priority Data
Jul. 26, 2006 (KR) 10-2006-0070110

(51) Int. Cl. G09G 3/28

(52) U.S. Cl. 345/60

(57) ABSTRACT

Provided is a front substrate of a plasma display panel. The front substrate includes a front glass substrate; a number of pairs of first electrodes which are formed in parallel with each other on the front glass substrate, and are made of a transparent conductive material; a number of pairs of second electrodes which are formed in parallel with each other on the front glass substrate, and are made of a material whose specific resistance is relatively smaller than that of the material of the first electrode; and a number of auxiliary electrodes which electrically connects the first electrodes with the second electrodes, to thereby make an area of the first electrode contribute to brightness and to thus raise a contrast ratio and improve a luminous efficiency greatly.

### CROSS-REFERENCE TO RELATED PATENT APPLICATIONS

This application claims the benefit of Korean Patent Application No. 10-2006-0070110 filed on Jul. 26, 2006, in the Korean Intellectual Property Office, the disclosure of which is incorporated herein in its entirety by reference.

### BACKGROUND OF THE INVENTION

1. Field of the Invention

The present invention relates to a plasma display panel, and more particularly, to a plasma display panel in which an auxiliary electrode which electrically connects a bus electrode and a transparent electrode is installed to heighten a contrast ratio and improve a luminous efficiency.

2. Description of the Related Art

In general, a plasma display panel (PDP) displays images thereon using a gas discharge phenomenon, and shows various excellent display abilities in view of a display capacity, brightness, contrast ratio, afterimage, and an angle of vision, and enables implementation of thin and large-area devices. Accordingly, the plasma display panel (PDP) replaces an existing cathode-ray tube (CRT), in a TV or monitor market from several years ago, and is placed on a representative digital device together with a Thin Film Transistor Liquid Crystal Display (TFT LCD).

In the plasma display panel (PDP), plasma discharge occurs by discharge gas which is filled in a cell between electrodes by a direct-current (DC) voltage or alternating-current (AC) voltage, and fluorescent materials are excited by emission of ultra violet rays accompanying the plasma discharge, to thus emit light.

FIG. 1 is a perspective view showing a part of a conventional plasma display panel. The plasma display panel of FIG. 1 has a structure that respective color light emitting cells are arranged in a matrix form, and illustrates an alternating-current (AC) surface discharge type plasma display panel. In FIG. 1, a front glass substrate 8 and a rear glass substrate 9 are arranged in parallel with each other and a barrier ribs 3 is interposed between the front glass substrate 8 and the rear glass substrate 9. A scanning electrode 5 and a sustain electrode 6 which form a discharge electrode pair are arranged on the front glass substrate 8 in parallel with each other. A dielectric layer 7a and a protective layer 2a are formed to cover the scanning electrode 5 and the sustain electrode 6.

On the other hand, an address electrode 4 is arranged on the rear glass substrate 9, orthogonal with the scanning electrode 5. Respective color fluorescent material layers 7 are arranged in spaces partitioned by the barrier ribs 3 between the dielectric substance layer 7b and both plates, respectively. A discharge gas (fox example, neon or xenon) is filled and sealed in the spaces. Accordingly, the plasma display panel has a structure that the respective color light emitting cells are formed.

FIG. 2 is a plan view showing an electrode structure which is formed on the front substrate of the conventional plasma display panel illustrated in FIG. 1.

Referring to FIG. 2, the plasma display panel uses a principle that plasma discharge occurs if a voltage is applied between two electrodes. The plasma display panel includes a pair of a transparent electrode 2 and a bus electrode 1 which forms the scanning electrode 5 and the sustain electrode 6, respectively, and the barrier ribs 3 which is orthogonal with the scanning electrode 5 and the sustain electrode 6, and is formed on the rear substrate 9 to thereby provide a structure of securing certain spaces to cause discharge.

Here, discharge occurs between a pair of the transparent electrodes 2 which are main electrodes that cause discharge. The bus electrodes 1 play a role of supplying electric current supplied through ends of the bus electrodes 1 for the whole electrode lines quickly.

Here, the transparent electrode 2 is transparent but has electrical conductivity. Accordingly, the transparent electrode 2 is an essential material for a display device. However, since the transparent electrode 2 has specific resistance of about 10⁻³ Ω·cm, it has insufficient electrical conductivity to be used as an electrode for a large-size plasma display panel. If the transparent electrode 2 is used for the large-size plasma display panel, voltage drops are caused all over lines and nonhomogeneous electrical characteristics appear all over the whole area of the panel.

Therefore, the bus electrode 1 having Ag whose specific resistance is very low as about 10⁻⁶ Ω·cm as a main ingredient is formed on the transparent electrode 2 to thereby solve the above-described problem.

Meanwhile, a method of forming the transparent electrode 2 employs coating an indium tin oxide (ITO) film on a glass substrate by sputtering and patterning the resultant product by photolithography (including exposure, developing, and etching).

In addition, various methods are known to form the bus electrode 1. According to the most representative method, paste that contains photosensitive material having Ag as a main ingredient is printed on a substrate, and the resultant product is patterned using photolithography.

Meanwhile, since the transparent electrode 2 and the bus electrode 1 are electrically connected with each other, it is important to align the bus electrode 1 on the transparent electrode 2 in place. As illustrated, the bus electrode 1 is generally located at a distance “A” from the outer block of the transparent electrode 2. The reason is to put a margin so that the bus electrode 1 is well aligned with the transparent electrode 2 all over the panel.

In this case, assuming that a line width of the bus electrode 1 is “B,” an area equivalent to “B” does not contribute in brightness at the time of plasma discharge and consumes electric power. Areas equivalent to “A” and “C” contribute in brightness.

Here, “A” is 10˜20 μm, “B” is 50˜100 μm, and “C” is 100˜300 μm. The area that “B” occupies reaches about 30˜40% of the whole transparent electrode area. As a result, a very big area of the transparent electrode does not contribute in brightness, and electric power is wasted accordingly.

FIGS. 3A through 4B are plan views and cross-sectional views showing a front substrate structure in which a black stripe is added in the conventional plasma display panel, respectively.

First, FIGS. 3A and 3B are a plan view and a cross-sectional view showing an electrode structure of a conventional PDP front substrate in the case that bus electrodes and black stripes are formed at the same time using the same material.

Referring to FIGS. 3A and 3B, electrodes of the PDP front substrate include transparent electrodes 2a, 2b, and 2a′ to a front glass substrate 8, and bus electrodes 1a, 1b, and 1a′ which are electrically connected in contact with the upper portions of the transparent electrodes 2a, 2b, and 2a′. Thus, since voltage supplied for the bus electrodes 1a, 1b, and 1a′ is supplied for the transparent electrodes 2a, 2b, and 2a′ as it is, plasma discharge occurs in a gap between the transparent electrode 2a and the adjoining transparent electrode 2b by a voltage difference between the bus electrodes 1a and 1b.

As illustrated, in the case of an actual PDP panel, a plurality of pairs of transparent electrodes 2a and 2b which form a pair with each other exist. In this case, discharge should occur only between the transparent electrodes 2a and 2b that accomplish one pair with each other, and the transparent electrodes 2a and 2b should be electrically insulated with the other adjoining transparent electrode 2a′.

For this reason, discharge happens between a pair of the transparent electrodes 2a and 2b forming one pair, but a wide gap is formed so that discharge does not happen between the transparent electrode 2b and the other adjoining transparent electrode 2a′ which does not accomplish one pair.

In other words, a gap that is, a space between the transparent electrode 2b and the other adjoining transparent electrode 2a′ is a non-discharge area, and plays a role of isolating the transparent electrode 2b and the other adjoining transparent electrode 2a′, so that light emitting by discharge occurs between lines of the transparent electrodes 2a and 2b which form one pair. In general, the space keeps a sufficient wide distance of hundreds μm so that charges generated by plasma discharge do not move to other adjoining transparent electrode pair lines.

However, the space is a portion which does not contribute in light emitting substantially in the PDP panel, and which plays a role of lowering an aperture ratio which is a ratio of light transmitted through the whole unit cell. Further, since the whole PDP panel brightness is lowered as this space becomes wider, the transparent electrodes 2a and 2b forming a pair and the other adjoining transparent electrodes 2a′ forming a pair should be isolated so that discharge does not happen therebetween, and simultaneously are designed properly considering brightness.

Meanwhile, a contrast ratio of the PDP panel is defined as a ratio of brightness between a black screen and a white screen, and is one of important quality factors in all display devices including PDPs.

Therefore, to heighten a contrast ratio of the PDP panel, a black material is formed on the PDP panel in the form of a black stripe or black matrix, to thereby heighten a black color degree in a black color screen.

As an example, a method of forming a pattern in a black stripe form on the front substrate and manufacturing the upper portion of a barrier ribs that exists in the horizontal and vertical directions on the rear substrate as a black color, is often used to improve s panel's black color degree in the case of the PDP.

Here, a method of forming a black color material in black bus electrodes which are lower portions 11a, 11b, and 11a′ of the bus electrodes 1a, 1b, and 1a′, and a black stripe 4a that is a non-discharge area, on the front substrate, is generally used. The reason is because the bus electrodes 1a, 1b, and 1a′ have Ag as a main ingredient and intercept light which happens by discharge, and the non-discharge area is a portion that does not contribute in light emitting, to thereby heighten a black color degree in a black color screen without suffering from a side effect that lowers brightness if a black color material is deposited in the non-discharge area.

Concretely, a method of improving a black color degree on the PDP front substrate, will be described below. There are a method of forming the lower portions 11a and 11b of the bus electrodes and the black stripe 4a at the same time and a method of forming the black stripe 4b separately.

First, the method of forming the lower black bus electrodes 11a and 11b of the bus electrodes 1a and 1b and the black stripe 4a at the same time is accomplished by the following process.

At First, black color paste is printed and dried on the transparent electrodes 2a and 2b, and Ag-series paste is printed and dried thereon, to thus get a 2-story structure dry film. Then, the resultant produce is exposed, developed and plasticized to thus get an electrode pattern.

Here, the black bus electrodes 11a and 11b and the black stripe 4a have a 2-story electrode structure in which a lower layer is made of a black material and an upper layer is made of Ag-series.

By the way, since a black material layer exists between the electrode made of Ag-series having good conductivity and the transparent electrodes 1a and 1b, a black color material need to be enough thin and have electric conductivity to a degree so as to electrically communicated therebetween. Accordingly, the method of simultaneously forming the bus electrodes 1a and 1b, the black bus electrodes 11a and 11b and the black stripe 4a has a shortcoming that a black color degree of the black color material may be insufficient in the case of finding and selecting a material of meeting both the electric conductivity and the black color degree.

Also, the bus electrodes 1a and 1b or the transparent electrodes 2a and 2b and the black stripe 4a have electric conductivity. Accordingly, they should be detached strictly from one another to prevent an electrical short-circuit. As illustrated, the line width of the black stripe 4a cannot cover the whole non-discharge area, and should be formed to have a certain margin of 20˜30 μm or more if the bus electrodes 1a, 1b, and 1a′ and the transparent electrodes 2a, 2b, and 2a′ and scattering of the whole process. Since this margin cannot be utilized as the electrodes, and cannot be utilized as the black stripe 4, it causes to lower an efficiency of the electrode structure.

Accordingly, to solve the problem of the method of simultaneously forming the bus electrode 1a and 1b and the lower portions 11a and 11b and the black stripe 4b, there a method of forming the black stripe 4b separately, as shown in FIGS. 4A and 4B.

Referring to FIGS. 4A and 4B, a method of forming the bus electrodes 1a and 1b and the black stripe 4b separately will be described below. In the case of the bus electrodes 1a and 1b, black color paste having electrical conductivity is printed and dried on the transparent electrodes 2a and 2b, and Ag-series paste is printed and dried thereon, to thus get a dry film, to then have the resultant produce exposed, developed and plasticized to thus get an electrode pattern of a 2-story structure, in the same manner as that of FIGS. 3A and 3B.

Meanwhile, in the case of forming the black stripe 4b, a separate process is performed before or after the process of the bus electrodes 1a and 1b. In this case, a pattern is directly printed or printed, dried, exposed, developed and plasticized using photosensitive paste.

In the case of a method forming the bus electrodes 1a and 1b and the black stripe 4b separately, the material of the black stripe 4b need not have electric conductivity at all. Accordingly, a material having a good black color degree is selected to make the black stripe 4b sufficiently thick, to exhibit the black color degree sufficiently. A material which is electrically an insulator is used as the black stripe 4b. As a result, even if the black stripe 4b contacts the adjoining bus electrodes 1a′ or the transparent electrode 2a′, the non-discharge area can be filled with the black stripe 4b without having no risk of a short-circuit, to thereby heighten the black color degree of the panel.

However, if the black stripe 4b hides the transparent electrodes 2a, 2b, and 2a′, the method also deteriorates brightness. Taking this into account, a certain gap should be provided between the transparent electrodes 2a and 2a′ and the black stripe 4b. As a result, it is impossible to fill the non-discharge area with the black stripe 4b.

Also, in the case of a method of forming the bus electrodes 1a and 1b and the black stripe 4b separately, there is a fatal problem that a processing cost increases because the bus electrodes 1a and 1b and the black stripe 4b should be separately fabricated.

### SUMMARY OF THE INVENTION

To solve the above problems of the conventional art, it is an object of the present invention to provide a front substrate of a plasma display panel which improves a structure of the panel including an auxiliary electrode so that a transparent electrode area contributes in brightness at maximum.

It is another object of the present invention to provide a front substrate of a plasma display panel having a simple and economic manufacturing process, which can widen a black stripe area so as to be connected with the lower portion of a bus electrode to thereby greatly widen an area that black color occupies in the whole area of the PDP panel, and can use a material having a sufficient black color degree with no electrical conductivity as a material of a black stripe, to thereby heighten a black color degree and a contrast ratio greatly.

Other objects and advantages of the present invention will be described below, and recognized by exemplary embodiments of the present invention.

To accomplish the above object of the present invention, there is provided a front substrate of a plasma display panel comprising: a front glass substrate; a number of pairs of first electrodes which are formed in parallel with each other on the front glass substrate, and are made of a transparent conductive material in which plasma discharge is performed in discharge gas filled in respective cells; a number of pairs of second electrodes which are formed in parallel with each other on the front glass substrate, and are made of a material whose specific resistance is relatively smaller than that of the first electrodes, in which the second electrodes are formed in parallel with the first electrodes so as to partially overlap with or adjoin to the first electrodes; and a number of auxiliary electrodes which electrically connects the first electrodes with the second electrodes.

Preferably but not necessarily, the auxiliary electrodes are formed so that they are not projected to the outside of the first electrodes to thereby prevent a short-circuit.

Preferably but not necessarily, the first electrodes are respectively made of indium tin oxide (ITO) or SnO₂, and the second electrodes are respectively made of a conductive material having one selected from the group consisting of Ag, Al, Cr, and Cu as a main ingredient, in which the first electrodes are a bar type or a segment type with a number of projections, respectively.

Preferably but not necessarily, a number of the auxiliary electrodes need not correspond to the first electrodes on a one-to-one basis necessarily in every discharge cell, respectively but may correspond to the first electrodes while jumping over a number of the discharge cells, respectively.

Preferably but not necessarily, a number of the auxiliary electrodes should have electric conductivity because they play a part of electrically connecting the first electrodes and the second electrodes, but all of the auxiliary electrodes need not be made of an electrical conductive material, and part of the auxiliary electrodes can be formed of a black color material having no electrical conductivity in order to improve a black color degree of the panel.

Preferably but not necessarily, a black stripe is further formed in a non-discharge area which is formed between the first electrode pair and the neighboring first electrode pair for improvement of a contrast ratio, and the black stripe is widely formed extensively to an area including the lower portion of the second electrode pair by using a black color material having no electrical conductivity.

As described above, the front substrate of the plasma display panel according to the present invention comprises the auxiliary electrodes installed in the second electrodes being the bus electrodes, so that an area of the first electrodes being the transparent electrodes can contribute in brightness more effectively, to thereby improve a luminous efficiency greatly.

As described above, the present invention provides the front substrate of the plasma display panel, which can widen a black stripe area so as to be connected with the lower portion of a bus electrode to thereby greatly widen an area that black color occupies in the whole area of the PDP panel, and can use a material having a sufficient black color degree with no electrical conductivity as a material of a black stripe, to thereby heighten a black color degree and a contrast ratio greatly.

### BRIEF DESCRIPTION OF THE DRAWINGS

The above and other objects and advantages of the present invention will become more apparent by describing the preferred embodiment thereof in more detail with reference to the accompanying drawings in which:

FIG. 1 is a perspective view showing a part of a conventional plasma display panel;

FIG. 2 is a plan view showing an electrode structure which is formed on the front substrate of the plasma display panel illustrated in FIG. 1;

FIGS. 3A through 4B are plan views and cross-sectional views showing a front substrate structure in which a black stripe is added in the conventional plasma display panel, respectively;

FIG. 5 is a plan view showing structure of the front substrate of a plasma display panel according to a first exemplary embodiment of the present invention;

FIG. 6 is a plan view showing a modified exemplary embodiment in which position of auxiliary electrodes are changed in the front substrate of the plasma display panel shown in FIG. 5;

FIG. 7 is a plan view showing a modified exemplary embodiment in which the number of auxiliary electrodes is changed in the front substrate of the plasma display panel shown in FIG. 5;

FIGS. 8A and 8B are plan views showing a modified exemplary embodiment in which shapes of the first electrodes are changed in the front substrate of the plasma display panel shown in FIG. 5;

FIGS. 9A and 9B are a plan view and a cross-sectional view showing a front substrate structure in which a black stripe is added in the plasma display panel according to a second exemplary embodiment of the present invention, respectively; and

FIGS. 10A and 10B are graphical views showing a luminous efficiency and a brightness characteristic of the plasma display panel according to the present invention through experiments, respectively.

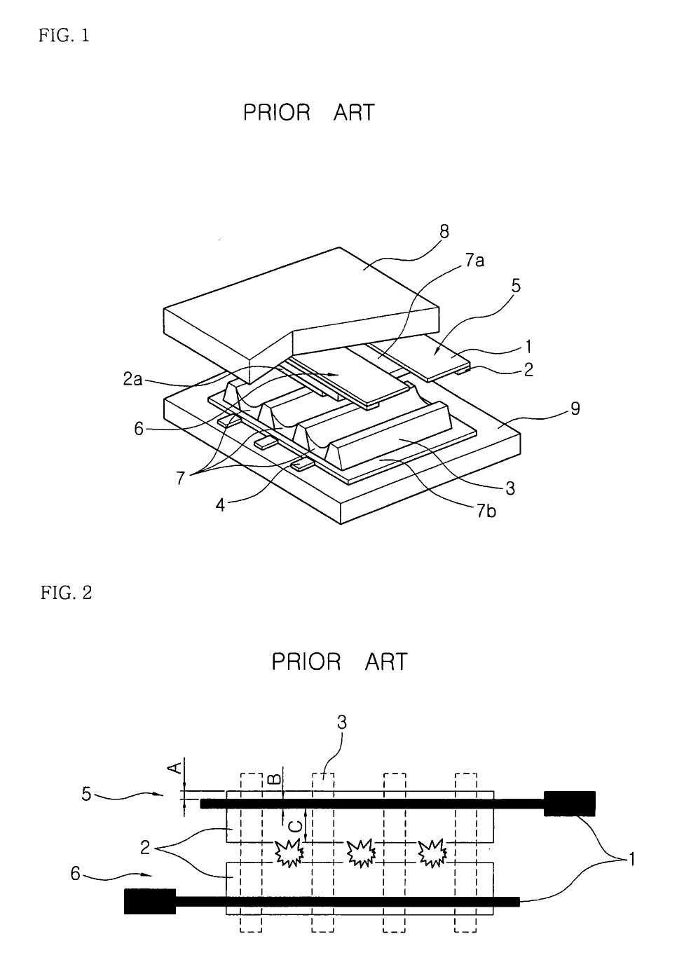

### DETAILED DESCRIPTION OF THE INVENTION

A front substrate of a plasma display panel according to respective embodiments of the present invention will be described with reference to the accompanying drawings.

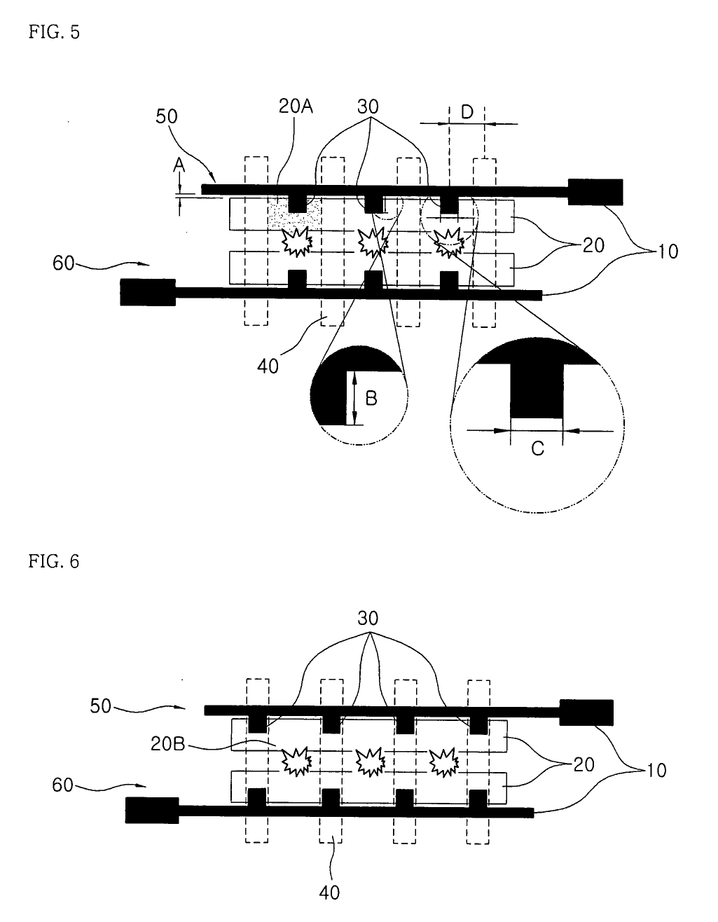

FIG. 5 is a plan view showing structure of the front substrate of a plasma display panel according to a first exemplary embodiment of the present invention.

Referring to FIG. 5, the front substrate of the plasma display panel according to the first exemplary embodiment of the present invention includes a front glass substrate (not shown), a number of scanning electrodes 50 which are formed in parallel with each other on the front glass substrate, and a number of sustain electrodes 60 which are formed in parallel with each other on the front glass substrate, and are formed in opposition to the number of scanning electrodes 50 so that discharge can occur between the number of scanning electrodes 50 and the number of sustain electrodes 60.

Here, as illustrated in FIG. 5, plasma discharge occurs in discharge gas by a voltage difference between the scanning electrodes 50 and the sustain electrodes 60. The scanning electrodes 50 and the sustain electrodes 60 are made of first electrodes 20 and second electrodes 10, in which the first electrodes 20 are respectively made of a transparent material, for example, indium tin oxide (ITO) or SnO₂, and the second electrodes 10 are respectively made of a material whose specific resistance is relatively smaller than that of the first electrodes 20, for example, a conductive material having one selected from the group consisting of Ag, Al, Cr, and Cu as a main ingredient. Here, the second electrodes 10 are bus electrodes on which a number of auxiliary electrodes 30 are extensively formed so that the second electrodes 10 are formed in parallel with each other adjacent to the first electrodes 20 and electrically connected with the first electrodes 20 in respective cells.

Here, the second electrodes 10 are arranged at the outside of the first electrodes 20. This is because there is no need to have the lines of the second electrodes 10 on the first electrodes 20 as in the conventional art, due to the auxiliary electrodes 30 which are connected with the second electrodes 10 and electrically contact the first electrodes 20.

In addition, as illustrated in FIG. 5, main electrodes which are horizontally arranged from the second electrodes 10 may be formed to have a certain gap “A” while adjoining with the first electrodes 20. Although it is not shown in the drawing, part of the second electrodes 10 may be overlapped over the first electrodes 20.

Therefore, according to the present invention, since the first electrodes 20 need not be located below the second electrodes 10, the first electrodes 20 are disposed at a distance from the second electrodes 10, or part of the first electrodes 20 are disposed to overlap the second electrodes 10. Accordingly, an area of the first electrodes 20 may contribute in brightness more effectively.

FIG. 6 is a plan view showing a modified exemplary embodiment in which position of auxiliary electrodes are changed in the front substrate of the plasma display panel shown in FIG. 5.

First, positions of the auxiliary electrodes 30 can be located in discharge cells 20A, as shown in FIG. 5, or can be located in portions crossing barrier ribs 40 as illustrated in FIG. 6.

Thus, if the auxiliary electrodes 30 are located at portions crossing the barrier ribs 40, as illustrated in FIG. 6, an area of light transmittance cells 20B widens relatively in comparison with the discharge cells 20A illustrated in FIG. 5, to thereby improve an aperture ratio.

Here, it is preferable that the length of each auxiliary electrode 30 is not protruded from the respective first electrodes 20, in order to avoid inferiority of electric short-circuit, etc.

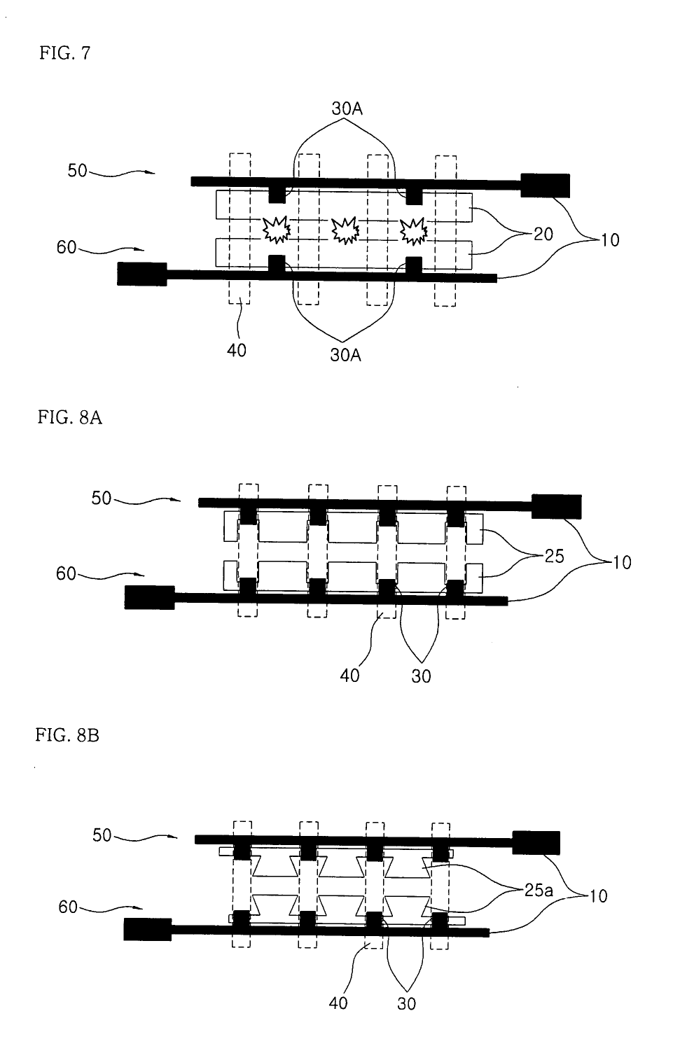

FIG. 7 is a plan view showing a modified exemplary embodiment in which the number of auxiliary electrodes is changed in the front substrate of the plasma display panel shown in FIG. 5. The auxiliary electrodes 30A can be located for respective cells 20A as shown in FIG. 5, as well as can be located one by one for several cells 20A as illustrated in FIG. 7.

FIGS. 8A and 8B are plan views showing a modified exemplary embodiment in which shapes of the first electrodes are changed in the front substrate of the plasma display panel shown in FIG. 5. Even in the case of the respective transparent electrodes where the first electrodes 25 and 25a are segment type, respectively, the auxiliary electrodes 30 can be connected with the respective cells as shown in FIGS. 8A and 8B.

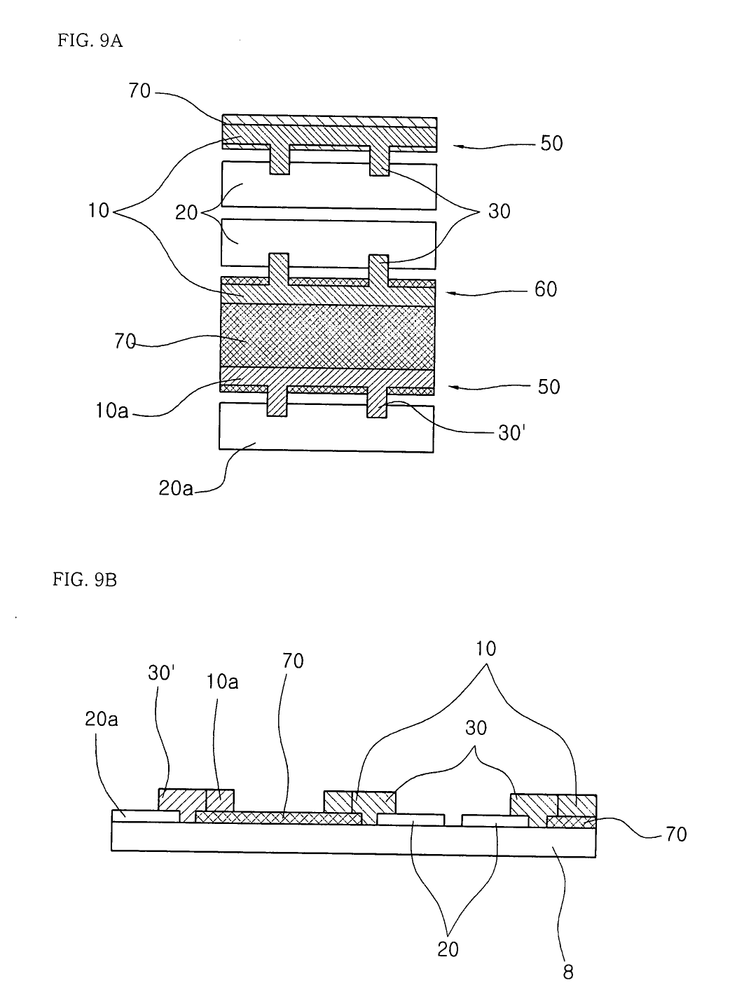

FIGS. 9A and 9B are a plan view and a cross-sectional view showing a front substrate structure in which a black stripe is added in the plasma display panel according to a second exemplary embodiment of the present invention, respectively.

First, a plasma display panel includes: a front glass substrate; a number of pairs of first electrodes 20 and 20a which are formed in parallel with each other on the front glass substrate, and are made of a transparent conductive material in which plasma discharge is performed in discharge gas filled in respective cells; a number of pairs of second electrodes 10 and 10a which are formed in parallel with each other on the front glass substrate, and are made of a material whose specific resistance is relatively smaller than that of the material of the first electrodes 20 and 20a, in which the second electrodes are formed in parallel with the first electrodes so as to partially overlap with or adjoin at a certain distance from the first electrodes 20 and 20a; and a number of auxiliary electrodes 30 and 30′ which are extensively formed from the second electrodes 10 and 10a, to thus electrically connect the first electrodes 20 and 20a with the second electrodes 10 and 10a.

Here, in the case that gaps between the first electrodes 20 and 20a and the second electrodes 10 and 10 are too big, the line width of the transparent electrodes required for discharge cannot be secured sufficiently. Thus, it is preferable that the gaps between the first electrodes 20 and 20a and the second electrodes 10 and 10 are limited to 200 μm or less which is half of the line width of the first electrodes 20 and 20a being the transparent electrodes.

Referring to FIGS. 9A and 9B, in order to improve a contrast ratio, black stripes 70 which are located down to the lower portions of the second electrodes 10 and 10a are formed between a pair of the first electrodes 20 and a neighboring first electrode 20a. The black stripes 70 are formed adjacent to the first electrodes 20 and 20a including the lower portions of the second electrodes 10 and 10a, to thus further improve a contrast ratio.

According to the present invention, this is because the second electrodes 10 and 10a which are the bus electrodes are separated from the first electrodes 20 and 20a which are the transparent electrodes, and the first electrodes 20 and 20a and the second electrodes 10 and 10a are connected through the auxiliary electrodes 30, to thereby enlarge an area even at the lower portions of the second electrodes 10 and 10a and to thus dispose the black stripes 70 having no electric conductivity.

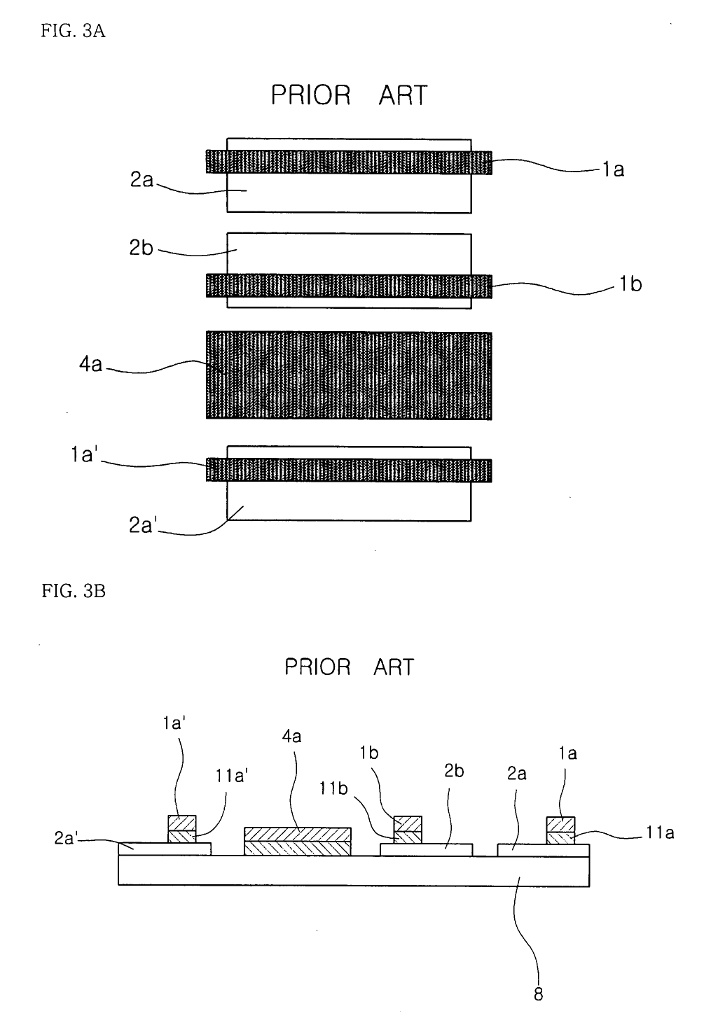

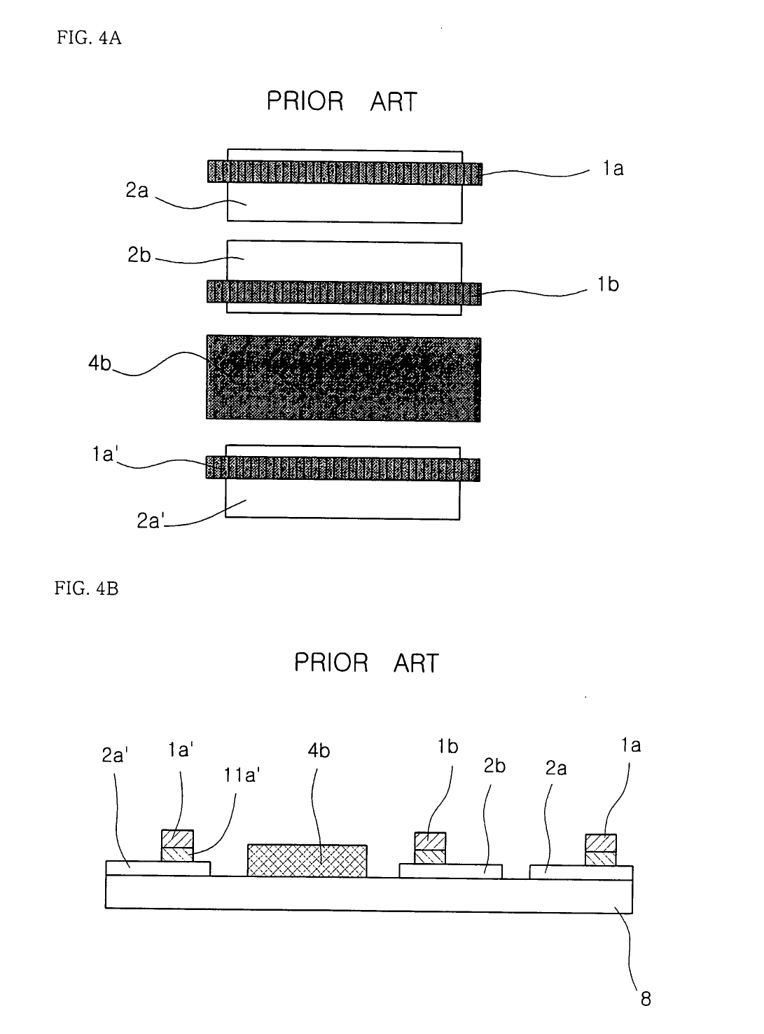

That is, in the case of the conventional art shown in FIGS. 3A, 3B, 4A and 4B, the second electrodes 10 and 10a should be detached from the black stripes 70. But, in the present invention, the areas of the black stripes 70 can be extended and connected to the lower portions of the second electrodes 10 and 10a.

Thus, the present invention can greatly widen an area that black color occupies in the whole area of the PDP panel, through an extended black stripe area and can use a material having a sufficient black color degree with no electrical conductivity as a material of the black stripes 70, so as to be formed thick, to thereby greatly heighten a black color degree and a contrast ratio of a plasma display device.

Here, since the auxiliary electrodes 30 should contact the first electrodes 20 and 20a, it is advantageous that the auxiliary electrodes 30 are made of only a conductive material such as Ag. However, the lower layers of the auxiliary electrodes 30 may be made of a black color material having electric conductivity, in order to further heighten a black color degree.

In addition, the auxiliary electrodes 30 may have a function of electrically connecting between the first electrodes 20 and 20a and the second electrodes 10 and 10a. Accordingly, the auxiliary electrodes 30 need not correspond to all cells 20A and 20B on a one-to-one basis as shown in FIGS. 5 and 6. As a result, an electrically conductive material is applied only to part of the auxiliary electrodes 30, and a black color material having no electric conductivity is applied to the other parts of the auxiliary electrodes 30.

Meanwhile, in the front substrate of the plasma display panel having the above-described structure, the positions and structures between the first electrodes 20 and 20a, the second electrodes 10 and 10a, and the auxiliary electrodes 30 influence upon the characteristics of the plasma display panel. The characteristics of the plasma display panel are changed according to how the positions and structures between the first electrodes 20 and 20a, the second electrodes 10 and 10a, and the auxiliary electrodes 30 are designed.

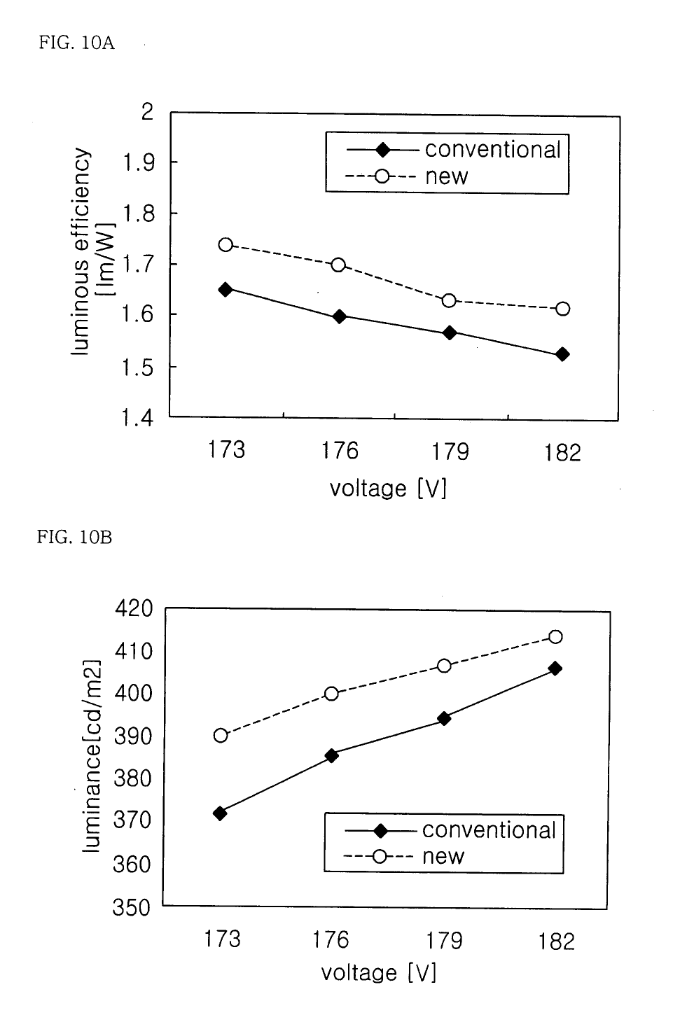

Here, in the present invention, an experiment has been executed to optimize the characteristics of the plasma display panel. An example of designing the first electrodes 20 and 20a, the second electrodes 10 and 10a, and the auxiliary electrodes 30 is illustrated in the following Table 1. The characteristics depending upon the design values are illustrated in FIGS. 10A and 10B as well as the following Table 2.

First, referring to FIG. 5, “A” denotes a gap between the second electrode 10 and the first electrode 20, “B” denotes a protruded length of the auxiliary electrode 30, “C” denotes the line width of the auxiliary electrode 30, and “D” denotes the relative position between the auxiliary electrode 30 and the barrier ribs 40, in which their design values are illustrated in the following Table 1.

TABLE 1

| | Conventional art | Present invention | |
|---|---|---|---|
| Width of 1st electrode | 320 μm | 270 μm | |
| Gap between 1st | 80 μm | 80 μm | |
| electrodes | | | |
| Width of 2nd electrode | 100 μm | 100 μm | |
| Auxiliary electrode | — | A: 0 μm | B: 200 μm |
| | | C: 70 μm | D: 0 μm |

| | | |
|---|---|---|
| Width of barrier ribs | 70 μm | 70 μm |

Characteristics of a luminous efficiency and a contrast ratio of the plasma display panel according to the present invention will be described comparing with the conventional technology.

First, the characteristics of the luminous efficiency and brightness of the plasma display panel which has been manufactured according to the above-described structure of the present invention and the conventional plasma display panel are illustrated in FIGS. 10A and 10B.

Referring to FIGS. 10A and 10B, when the graph (-◯-) showing the characteristics of the luminous efficiency and brightness of the plasma display panel according to the present invention is compared with the graph (-♦-) of the conventional art, it can be seen that the present invention has been improved more than about 10% than the conventional art.

In Table 2, a contrast ratio of the plasma display panel according to the present invention is compared with the conventional plasma display panel.

Referring to Table 2, the contrast ratio of the plasma display panel which has been manufactured according to the present invention is much higher than that of the conventional plasma display panel.

TABLE 2

| | Reflected luminance | Display luminance | Contrast ratio |
|---|---|---|---|
| Conventional | 15 cd/m² | 432 cd/m² | 29:1 |
| art | | | |
| Present | 12 cd/m² | 529 cd/m² | 44:1 |
| invention | | | |

Therefore, in the front substrate of the plasma display panel according to the present invention of the above-described structure, a number of the auxiliary electrodes 30 and 30′ which electrically connect the second electrodes 10 and 10a and the first electrodes 20 and 20a are extensively formed with respect to the second electrodes 10 and 10a. Accordingly, the whole area of the second electrodes are placed on the first electrodes in the conventional art, but only the extreme part of the second electrodes 10 and 10a is placed on the first electrodes 20 and 20a in the present invention. As a result, the present invention can reduce an ineffective power consumption by a portion which is hidden by the second electrodes 10 and 10a, to thereby improve a luminous efficiency, that is, brightness per unit power consumption. As being the case, all the area of the first electrodes 20 and 20a can contribute 100% in brightness without being screened by the second electrodes 10 and 10a, to thereby heighten a contrast ratio and greatly improve a luminous efficiency which is the biggest solution subject of the plasma display panel.

Thus, the present invention can greatly widen an area that black color occupies in the whole area of the PDP panel, through an extended black stripe area and can use a material having a sufficient black color degree with no electrical conductivity as a material of the black stripes 70, so as to be formed thick, to thereby greatly heighten a black color degree and a contrast ratio of a plasma display device.

As described above, according to the present invention, the transparent electrodes and the bus electrodes are electrically connected with each other, and the auxiliary electrodes of a form which are arranged vertically with respect to the transparent electrodes, so that the area of the transparent electrodes can contribute in brightness more effectively, to thus greatly improve a luminous efficiency, and to thus greatly improve a black color degree and a contrast ratio of the PDP panel through an extended black stripe area.

As described above, the present invention has been described with respect to particularly preferred embodiments. However, the present invention is not limited to the above embodiments, and it is possible for one who has an ordinary skill in the art to make various modifications and variations, without departing off the spirit of the present invention and within the equivalent to the scope of the following claims.

What is claimed is:

1. A front substrate of a plasma display panel comprising:
a front glass substrate;
a number of pairs of first electrodes which are formed in parallel with each other on the front glass substrate, and are made of a transparent conductive material in which plasma discharge is performed in discharge gas filled in respective cells;
a number of pairs of second electrodes which are formed in parallel with each other on the front glass substrate, and are made of a material whose specific resistance is relatively smaller than that of the first electrodes, in which the second electrodes are formed in parallel with the first electrodes so as to partially overlap with or adjoin to the first electrodes; and
a number of auxiliary electrodes which electrically connects the first electrodes with the second electrodes.

2. The front substrate of a plasma display panel according to claim 1, wherein the auxiliary electrodes are formed so that they are not projected to the outside of the first electrodes to thereby prevent a short-circuit.

3. The front substrate of a plasma display panel according to claim 1 or 2, wherein the first electrodes are respectively made of indium tin oxide (ITO) or SnO₂, and the second electrodes are respectively made of a conductive material having one selected from the group consisting of Ag, Al, Cr, and Cu as a main ingredient.

4. The front substrate of a plasma display panel according to claim 1, wherein the first electrodes are a bar type or a segment type with a number of projections, respectively.

5. The front substrate of a plasma display panel according to claim 1, wherein a number of the auxiliary electrodes do not correspond to the first electrodes on a one-to-one basis necessarily in every discharge cell, respectively but correspond to the first electrodes while jumping over a number of the discharge cells, respectively.

6. The front substrate of a plasma display panel according to claim 1, wherein a part of the number of the auxiliary electrodes are made of an electrically conductive material and the other parts are made of a black color material.

7. The front substrate of a plasma display panel according to claim 1, wherein a black stripe is further formed between the first electrode pair and the neighboring first electrode pair for improvement of a contrast ratio, and the black stripe is widely formed extensively to an area including the lower portion of the second electrode pair.
